(19) United States
(12) Patent Application Publication
(10) Pub. No.: US 2024/0117216 A1
(43) Pub. Date: Apr. 11, 2024

(54) POLYURETHANE COMPOSITIONS FOR SEALING PROTRUSIONS THROUGH PREAPPLIED WATERPROOFING SYSTEMS

(71) Applicant: GCP Applied Technologies, Inc., Alpharetta, GA (US)

(72) Inventors: David COZZENS, Burlington, MA (US); Xia CAO, Acton, MA (US)

(21) Appl. No.: 18/473,955

(22) Filed: Sep. 25, 2023

Related U.S. Application Data
(60) Provisional application No. 63/412,365, filed on Sep. 30, 2022.

(51) Int. Cl. C09D 175/12; C08G 18/32; C08G 18/48; C08G 18/66; C08G 18/67; C09D 7/62; E02D 31/06

(52) U.S. Cl. CPC C09D 175/12; C08G 18/3234; C08G 18/3281; C08G 18/4829; C08G 18/6688; C08G 18/675; C09D 7/62; E02D 31/06

(57) ABSTRACT

A polyurethane waterproofing membrane composition, method of use, and building product containing such composition. The polyurethane composition, upon cure, exhibits strong adhesion to the construction substrates on which it is applied as well as to concrete cast upon the cured membrane, producing a continuous and fully bonded waterproof system, even though different surfaces and surface textures are presented at the surface-to-surface joinder among various components within a pre-applied waterproofing construction site.

### CROSS-REFERENCE TO RELATED APPLICATION(S)

This application claims priority under 35 U.S.C. § 119(e) to U.S. Provisional Patent Application No. 63/412,365, filed Sep. 30, 2022, by David COZZENS et al., entitled “POLYURETHANE COMPOSITIONS FOR SEALING PROTRUSIONS THROUGH PREAPPLIED WATERPROOFING SYSTEMS,” which is assigned to the current assignee hereof and incorporated herein by reference in its entirety for all purposes.

### FIELD OF THE INVENTION

The present invention relates to waterproofing systems and methods in building and construction and, more particularly, to achieving tight waterproof bonds with various material surfaces such as concrete, synthetic polymer-containing membranes, and metals in soil retention assemblies having waterproofing membranes with penetrations due to pipes, steel rebar, rock anchors, and other detailing articles which present various surface-to-surface jointing or seaming challenges at a pre-applied waterproofing construction job site.

### BACKGROUND OF THE INVENTION

Pre-applied waterproofing, sometimes called “blind-side” or “reverse tanking” waterproofing, refers to an established practice in which a membrane is positioned against a substrate, such as horizontal or vertical formwork or “lagging,” subsequent to which a fresh concrete is “post-cast” against the membrane to form a building structure (e.g., a foundation) or a civil engineering structure (e.g., tunnel). In other words, waterproofing is installed first, and building is “cast” afterward.

U.S. Pat. No. 5,496,615 of Bartlett et al. discloses a pre-applied waterproofing membrane having a carrier layer (e.g., polymer film), a pressure-sensitive adhesive layer (e.g., non-bituminous), and a protective coating (e.g., dusted particulate layer), against which concrete is “post-cast” to achieve a waterproof bond when cured. In contrast to conventional “post-applied” membranes that are adhered to existing structures, pre-applied waterproofing membranes enable the concrete to be cast and waterproofed in the same operation in relatively tight spaces, such as in urban areas where one building structure might be constructed against another structure.

However, it is necessary to achieve waterproof bonding with post-cast concrete at overlaps and seams between adjacent membranes, as well as across concrete joints; and continuity of waterproofing barrier is a major objection when sealing around penetrations due to metal pipes, steel rebar, rock anchors, tiebacks, and other plastic or metal objects which present varied surface textures and materials.

In U.S. Pat. No. 8,475,909, Seth et al. disclosed pre-applied waterproofing membranes having three-dimensional, shaped contours useful for reverse-tanking waterproofing of detail areas such as those presented by tiebacks, pipes, pile caps, and other irregularities on concrete formworks. Tiebacks are large assemblies that secure the end of a rod, cable, or screw through waterproofing membrane and formwork to the soil or other adjacent structure against which the formwork is secured. The contoured membranes of Seth et al. were made of polymers that could be thermoformed to have shapes suitable for tiebacks (e.g., domed) or pipes (e.g., cylindrical) or other protrusions, and could employ waterproofing adhesives and protecting coatings similar to those used in the sheet-form membranes disclosed in U.S. Pat. No. 5,496,615 discussed above (See e.g., column 6, lines 17 et seq.). Various pre-applied membranes can be seamed together to provide a coherent waterproofing barrier despite penetrations caused by pipes, tiebacks, and other structures, and two-sided reverse tanking tape could be used to seam membrane components together. Such membranes and two-sided reverse tanking tapes are available from GCP Applied Technologies Inc. (Massachusetts) under the PREPRUFE® brand name.

Liquid applied compositions for dealing with penetration issues would appear to be preferred over tapes and membranes for reasons of speed and convenience, and some have been mentioned in the patent literature concerning pre-applied waterproofing applications. For example, U.S. Publication No. 20120198787A1 describes a method wherein a liquid waterproofing material is sprayed onto backing material which is said to avoid seams that otherwise might be caused by sheet membrane installation that is followed by subsequent application of an adhesion promoting layer. U.S. Publication No. 20200199840A1 describes application of a liquid membrane having a purported greater adhesion to post-cast concrete as compared to adhesion to the lagging wall. U.S. Publication No. 20130059082A1 describes two-part construction sealant compositions that could be cured upon application.

Although liquid compositions have been described in the literature and offered by almost all major pre-applied waterproofing product manufacturers, the present inventors believe that there remains an unmet need for a novel liquid detailing composition that can provide excellent bonding with various materials and their surfaces at penetration points: such as concrete surfaces (e.g., the post-cast concrete as well as pre-existing concrete of adjacent walls or structures), metal surfaces (e.g., pipes, steel reinforcing bars, fasteners, screws, etc.), and synthetic polymers (e.g., plastic or polymer carrier sheets of membranes or waterproofing meshes or fleeces). The liquid detailing composition needs to exhibit excellent adhesion to these various substances, not only to fill in the cavities and niches of the penetration point and surface irregularities, but also to bond strongly with all of these materials so that a continuous and fully bonded waterproofing system is established with the post-cast concrete, whereby leaks are prevented.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an improved liquid detailing membrane composition for below-grade pre-applied waterproofing is now met by a new, useful, and nonobvious invention.

In one aspect, disclosed herein is a method for integrating a pre-applied waterproofing membrane installed against a soil retention structure, wherein the pre-applied waterproofing membrane has at least one article penetrating there through, the method comprising the steps of: sealing the at least one penetration in the membrane by applying thereto a polyurethane composition by mixing together a first component A and a second component B, wherein, the first component A comprises at least one polyol in the amount of 20-90 wt. % based on total weight of polyurethane composition, and the second component B comprises at least one polyisocyanate having an NCO content in the range of from 2.0 to 50.0 wt. % measured according to ASTM D2572-19, with respect to said at least one polyisocyanate, wherein the first component A and the second component B are combined in a volume ratio of from 10:1 to 1:10; allowing the polyurethane composition to cure, wherein the composition, after curing for 7 days at 23° C., exhibits a Young's modulus (E) of from 0.05 to 1.0 MPa; and applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017).

In another aspect, provided herein is a package for providing a polyurethane composition, the package comprising: a first component (A) comprising at least one polyol in the amount of 20-90 wt. % based on total weight of the polyurethane composition; and a second component (B) comprising at least one polyisocyanate having an NCO content in the range of from 2.0 to 50.0 wt. % measured according to ASTM D2572-19, with respect to said at least one polyisocyanate, wherein when the first component A and the second component B are mixed in a volume ratio of from 10:1 to 1:10 to form a polyurethane composition and cured for 7 days at 23° C., the polyurethane exhibits a Young's modulus (E) of from 0.05 to 1.0 MPa, and wherein the polyurethane composition, when cured and in contact with hardened concrete, exhibits a peel adhesion with the hardened concrete is 3.0-50.0 pounds per linear inch (pli) or 0.525 to 8.756 Newtons per mm according to modified ASTM D903-98 (2017).

The embodiments of the invention can be used alone or in combination with each other.

### BRIEF DESCRIPTION OF THE DRAWINGS

A greater appreciation of the benefits and features of the present invention may be more readily comprehended when the following written description of exemplary embodiments is considered in conjunction with the drawings, wherein:

FIG. 1 is a diagrammatic illustration of an exemplary method and system of the invention wherein a liquid detailing composition of the present invention is applied to a penetration in a waterproofing membrane installed on a construction substrate, such as a lagging formwork.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

The waterproofing systems described herein are intended to bond with fresh cementitious compositions that are cast against them and allowed to harden. Cementitious compositions, such as concrete or mortar cement, which is applied this way to the waterproofing membranes, are sometimes referred to as being “post cast” or “post applied.”

The terms “cement” and “cementitious composition” are used to refer to dry powders as well as to pastes, mortars, grouts, and concrete compositions comprising a hydratable cement binder. The terms “paste”, “mortar” and “concrete” are terms of art: pastes are mixtures composed of a hydratable cement binder (usually, but not exclusively, Portland cement, masonry cement, or mortar cement). Mortars are pastes additionally including fine aggregate (e.g., sand), and concrete are mortars additionally including coarse aggregate (e.g., crushed gravel, stone). Cementitious compositions are typically formed by mixing hydratable cement, water, and fine and/or coarse aggregate.

Within the context of the present disclosure, the term “tackifier” refers to a compound that is incorporated into the composition and increases tack of the cured membrane. Tackifiers well known in the art include C5 aliphatic resins, C9 aromatic resins, rosin acids, rosin esters, hydrogenated resins of the above, and the like.

Within the context of the present disclosure, the term “plasticizer” refers to a compound that is incorporated into the composition and reduces the modulus of the cured membrane. Plasticizers well known in the art include organic esters, oils, low T_{g} oligomers, and the like.

Within the context of the present disclosure, the term “catalyst” refers to a compound that facilitates the reaction between an isocyanate functionality and an isocyanate-reactive functionality. Catalysts well known in the art include Tin carboxylates, Zinc carboxylates, Bismuth carboxylates, Aluminum or Zirconium chelates, tertiary amines, and the like.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5%, . . . 50%, 51%, 52% . . . 95%, 96%, 97%, 98%, 99%, or 100%. Moreover, any numerical range represented by any two values of R, as calculated above, is also specifically disclosed.

Disclosed herein is a method for integrating a pre-applied waterproofing membrane installed against a soil retention structure, wherein the pre-applied waterproofing membrane has at least one article penetrating there through, the method comprising the steps of: sealing the at least one penetration in the membrane by applying thereto a polyurethane composition by mixing together a first component A and a second component B, wherein, the first component A comprises at least one polyol in the amount of 20-90 wt. % based on total weight of the first component A, and the second component B comprises at least one polyisocyanate having an NCO content in the range of from 2.0 to 50.0 wt. % measured according to ASTM D2572-19, with respect to said at least one polyisocyanate, wherein the first component A and the second component B are combined in a volume ratio of from 10:1 to 1:10; allowing the polyurethane composition to cure, wherein the composition, after curing for 7 days at 23° C., exhibits a Young's modulus (E) of from 0.05 to 1.0 MPa; and applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017).

In some embodiments, the soil-retention system is selected from the group consisting of lagging, formwork, shotcrete, mud slabs, and crushed stone.

According to the “reverse tanking” waterproofing technique, a waterproofing membrane is first attached with the back side of its carrier sheet against a “formwork” (i.e., concrete mold usually formed by wooden boards joined together). Consequently, the waterproofing adhesive layer faces outwards. A concrete structure is created by casting concrete against the membrane-covered formwork surface, and this may be referred to as “post cast” or “post applied” concrete. The adhesive layer is covered by an elastomeric protective coating layer, a particle coating layer, or mixture or arrangement of both (i.e., either individually, mixed together as one layer, or arranged as discrete layers), to protect the adhesive from dirt and damage. This protective coating layer (whether polymeric or particle coating) also operates to decrease the tack of the adhesive. The outer surface is further protected by a release sheet liner (that must be removed before fresh concrete is poured against the adhesive/protective coating layers). After curing, the concrete is bonded with the adhesive/protective coating layers, and thus a waterproofing bond is achieved in “reverse” order.

Hence, in the world of “reverse tanking” waterproofing, it can be said that the waterproofing is “pre-applied” because it precedes the concrete structure; and, in turn, the concrete is said to be “post cast” or “post applied” because it follows the installation of waterproofing.

Reverse tanking is further discussed in U.S. Pat. Nos. 5,496,615 and 6,500,520 which teach using particle coating layers. In the '615 patent, inorganic particles are used to resist foot traffic when the membrane is installed on a horizontal surface. In the '520 patent, particles are applied on top of an adhesive layer to enhance bonding with concrete by reacting with calcium hydroxide generated during the hydration of cement.

One of the difficulties of reverse tanking is achieving continuity of waterproofing in detail areas (i.e., surface irregularities), and especially in “tieback” detailing. Tiebacks are the terminal ends of rods or cables supporting the formwork and are found protruding at intervals through the formwork surface. Other surface irregularities include penetration areas, such as where pipes or pile caps extend through the formwork. Common surface irregularities are found in soil-retention systems such as any one of lagging, formwork, shotcrete, mud slabs, or crushed stone against which is disposed or attached a plurality of waterproofing membranes having a synthetic polymer sheet, nonwoven, or mesh sheet-like body or synthetic polymer pressure-sensitive adhesive; and the plurality of sheet-like waterproofing membranes having at least two penetrations from articles chosen from pipe, steel reinforcement bar, rock anchor, screws, or a combination thereof.

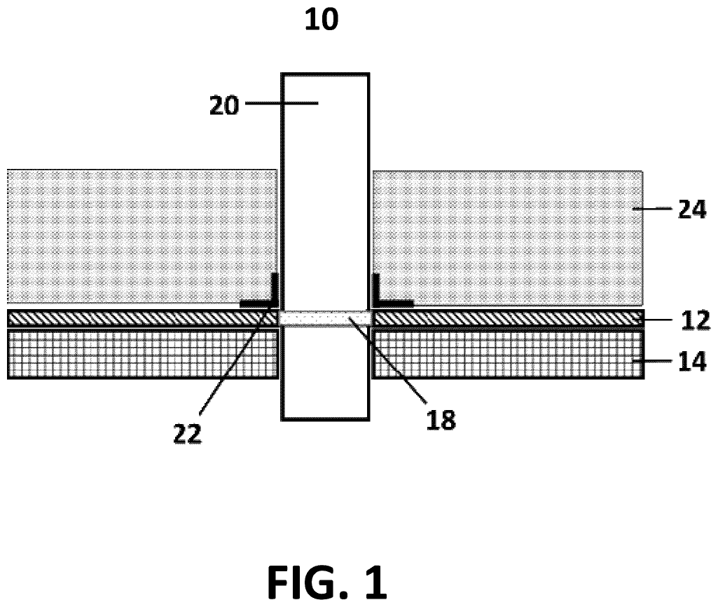

FIG. 1 illustrates an exemplary system 10 comprising penetrating objects that can be waterproofed by the methods disclosed herein. In system 10, at least one and, more preferably, a plurality of waterproofing membranes 12 are attached or fastened to a lagging formwork 14. For ease of illustration, one example waterproofing membrane 12 is shown, having at least one perforation 18 through which a metal structure 20 extends (i.e., at least one penetration). The metal structure 20 can be a pipe, steel reinforcing bar (“rebar”), fastener, a rock anchor, screws, tie-back, or other object. Exemplary waterproofing detailing composition 22 of the present invention coating is applied at the penetration area to bond with the membrane 12, with the metal structure 20, and with post-cast concrete 24.

The composition of the waterproofing membrane 12 is not critical to the present invention and the membrane can be any waterproofing single or multi-layer membrane known to those skilled in the art such as, for example, those disclosed in U.S. Pat. Nos. 8,475,909 and 10,267,049 as well as products sold under the PREPRUFE® brand name by GCP Applied Technologies, Inc.

The method disclosed herein comprises the step of sealing at least one penetration in the membrane and, in particular, sealing the penetrating object at its base, i.e., where it penetrates through the membrane thereby creating a seam through which water can penetrate. The membrane can be “sheet form” or shaped. The sealing step comprises applying to the seam a polyurethane composition by mixing together a first component (A) and a second component (B), wherein, the first component (A) comprises at least one polyol in the amount of 20-90 wt. % based on total weight of the first component (A), and the second component (B) comprises at least one polyisocyanate having an NCO content in the range of from 2.0 to 50.0 wt. % measured according to ASTM D2572-19, with respect to said at least one polyisocyanate, wherein the first component (A) and the second component (B) are combined in a volume ratio of from 10:1 to 1:10.

Polyol (A)

A polyol (A) is used to make the polyurethane composition. The polyol (A) may be used individually or in two or more polyols. For example, the polyol (A) may comprise a mixture of a diol and a triol. In some embodiments, the triol is present in the mixture in an amount of about 0.10 to about 10.0% by weight based on the total weight of the polyol component (A). In the polyurethane curable composition of the present invention, the total polyol (A) has an average hydroxyl value of preferably 1 to 300 mg KOH/g, more preferably 5 to 250 mg KOH/g, even preferably 10 to 200 mg KOH/g, especially preferably 30 to 150 mg KOH/g, and most preferably 20 to 100 mg KOH/g.

The polyol (A) is a compound having two or more active hydrogens at a terminal, and a polyol having two or more functional groups and a molecular weight of 50 to 20,000 Da. The polyol (A) can include an aliphatic alcohol, an aromatic alcohol, a polyether polyol, a polyester polyol, a polyolefin polyol, an acrylate polyol, and the like. The polyol (A) may also include polyamides, polydienes, polyacrylates, polycarbonates, polyaspartics, polysiloxanes, lignins, castor oil and its derivatives, or halogen-substituted derivatives of the above. Non-polymeric polyols are also well known in the art and can be employed herein and include, for example, ethylene glycol, diethylene glycol, triethylene glycol, 1,4-butanediol, 1,6-hexanediol, glycerol, pentaerythritol, neopentyl glycol, triethanolamine, hydroquinone, and other aromatic or aryl polyols. When the molecule contains only one hydroxyl functionality, the compound is used to cap the polymer chain, producing a terminal functionality corresponding to the R group of that particular compound, and limiting degree of polymerization. When the molecule possesses two or more hydroxyl functionalities the polymer chain is extended and/or crosslinked upon reaction with the isocyanate component(s).

The aliphatic alcohol may be any of dihydric alcohol and a polyhydric alcohol having a hydricity of three or higher (trihydric alcohol, tetrahydric alcohol, and the like). The dihydric alcohol includes alkylene glycol (alkylene glycol having about 1 to 6 of carbon atoms) such as ethylene glycol, propylene glycol, 1,3-propanediol, 1,3-butanediol, 1,4-butanediol, 1,5-pentanediol, 1,6-hexanediol, 3-methyl-1,5-pentanediol, neopentylglycol, and dehydrative condensate (diethyleneglycol, dipropyleneglycol, tripropyleneglycol and the like) from two or more molecules of the alkyleneglycol (for example, 2 to 6 molecules and the like). The trihydric alcohol includes glycerol, trimethylolpropane, trimethylolethane, 1,2,6-hexanetriol (especially trihydric alcohol having about 3 to 10 carbon atoms). The tetrahydric alcohol includes pentaerythritol, diglycerol and the like. In addition, the aliphatic alcohol includes sugars such as monosaccharide, oligosaccharide, and polysaccharide.

The aromatic alcohol includes bisphenols such as bisphenol A and bisphenol F; biphenyls such as dihydroxybiphenyl; polyhydric phenol such as hydroquinone, phenol formaldehyde condensate; naphthalenediol and the like.

The polyether polyol includes a random or block copolymer and the like obtained by ring-opening polymerizing ethylene oxide, propylene oxide, butylene oxide, styrene oxide and the like under the presence of one or two or more active hydrogen-containing initiator(s), and a mixture thereof. The active hydrogen-containing initiator includes diols such as ethylene glycol, diethylene glycol, propylene glycol, dipropylene glycol, 1,3-butane diol, 1,4-butane diol, 1,6-hexane diol, neopentyl glycol, bisphenol triols such as trimethylol ethane, trimethylol propane, glycerin; sugars such as monosaccharide, oligosaccharide, polysaccharide; sorbitol; amines such as ammonia, ethylenediamine, urea, monomethyldiethanol amine, monoethyldiethanol amine.

The polyester polyol includes a polymer obtained by condensating diprotic acids and anhydrides thereof such as maleic acid, fumaric acid, adipic acid, sebacic acid, phthalic acid, dodecanedioic acid, isophthalic acid, azelaic acid, with polyhydric alcohols such as ethylene glycol, propylene glycol, 1,4-butandiol, 1,6-hexandiol, diethylene glycol, dipropylene glycol, neopentyl glycol, 3-methyl-1,5-pentanediol under the presence of the esterification catalyst in the range of the temperature of 150 to 270° C. Further, the polyester polyol includes a ring-opening polymer such as ε-caprolactone and valerolactone, and an active hydrogen compound having two or more active hydrogens such as polycarbonate diol and castor oil.

The polyolefin polyol includes polybutadiene polyol, polyisoprene polyol and hydrogenated products thereof.

The acrylate polyol includes a copolymer of a monomer having a hydroxyl group such as hydroxyl ethyl (meth) acrylate, hydroxyl butyl (meth) acrylate, and vinyl phenol with a generic monomer such as n-butyl (meth)acrylate, 2-ethylhexyl (meth)acrylate, as well as a mixture thereof.

As used herein, “(meth)acrylate” includes acrylate and methacrylate.

Among these compounds, the polyol (A) preferably comprises at least one difunctional polyol selected from the group consisting of polyethers and polyesters, polyacrylates, polyolefins, polysiloxanes, polycarbonates, castor oil derivatives, fatty acid-based polyols, and mixtures thereof.

A mixture of diol and triol is preferred wherein the triol is used to achieve the desired crosslink density.

The polyol (A) may also include a polyester polyol in addition to a polyether polyol, from the viewpoint of imparting adhesiveness.

In some embodiments, the polyol (A) includes a polyester polyol in an amount of preferably 50% by mass or less, more preferably 30% by mass or less, even preferably 20% by mass or less, even more preferably 10% by mass or less, and particularly preferably 0% by mass, per 100% by mass of the polyol (A). If the amount of a polyester polyol is too much, the viscosity of the composition may increase, and the cured composition may not exhibit rubber elasticity due to the crystallinity of the polyester polyol.

The number average molecular weight of the polyol (A) of the present invention is preferably 50 to 20,000, more preferably 100 to 10,000, even preferably 300 to 5,000, and especially preferably 1,000 to 5,000 based on polystyrene by GPC. In the case where the number average molecular weight is less than 50, the elongation and strength of the cured product obtained are insufficient in some cases. In the case where the number average molecular weight is greater than 20000, a cured composition has a high viscosity and lowered workability in some cases.

Hydroxyl value of the polyol (A) is obtained with the method based on the standard of ASTM D4274-21.

As the constituent of the polyurethane composition, the amount of the polyol (A) is preferably present in the amount of from 7 to 90 wt. % based on the total weight of the first component (A). In other words, the polyol (A) may include other components such as, without limitation, additives as detailed below or the polyol (A). In other embodiments, the amount of the polyol (A) is preferably present in the amount of from 20 to 90 wt. % based on the total weight of the first component (A).

Polyisocyanate (B)

The polyisocyanate (B) is reacted with the polyol (A) to make the polyurethane employed in the method of the present invention. The “polyisocyanate component” (B) refers to one or more organic species possessing the isocyanate functionality, i.e., R—N═C═O. The number of isocyanate functional groups on a molecule can range from 1 to 100. Preferably, the at least one polyisocyanate has an NCO content in the range of from 2.0 to 50.0 wt. % measured according to ASTM D2572-19, with respect to said at least one polyisocyanates.

Isocyanates are a class of organic compounds characterized by their end groups, and consequently, the molecular or macromolecular architectures are manifold. These include aliphatic polyisocyanates, aromatic polyisocyanates, or isocyanate oligomers formed by the reaction product of excess isocyanate moieties to hydroxyl, amine, or carboxylic acid moieties.

The polyisocyanate (B) may be used individually or in combination of two or more polyisocyanates. The polyisocyanate (B) is an essential component for reacting with the polyol (A) of the present invention and forming a polyurethane in the curable composition.

Conventionally known polyisocyanate compounds are used as the polyisocyanate (B). Conventionally known polyisocyanate compounds include a diisocyanate compound and a polyisocyanate compound other than the diisocyanate compound. The diisocyanate compound includes, for example, an aliphatic diisocyanate compound, an alicyclic diisocyanate compound, an aromatic and aliphatic diisocyanate compound, an aromatic diisocyanate compound and the like. The concrete examples of these are exemplified below.

The aliphatic diisocyanate compound includes trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, and 2,6-diisocyanato methyl caproate.

The alicyclic diisocyanate compound includes 1,3-cyclopentene diisocyanate, 1,4-cyclohexane diisocyanate, 1,3-cyclohexane diisocyanate, 3-isocyanate methyl-3,5,5-trimethylcyclohexylisocyanate, 4,4′-methylenebis (cyclohexylisocyanate), methyl-2,4-cyclohexane diisocyanate, methyl-2,6-cyclohexane diisocyanate, 1,3-bis(isocyanatomethyl)cyclohexane, 1,4-bis(isocyanatomethyl)cyclohexane, and isophorone diisocyanate.

The aromatic and aliphatic diisocyanate compound includes 1,3- or 1,4-xylylendiisocyanate or a mixture thereof, ω,ω′-diisocyanato-1,4-diethyl benzene, and 1,3- or 1,4-bis (1-isocyanato-1-methylethyl)benzene or a mixture thereof.

The aromatic diisocyanate compound includes m-phenylene diisocyanate, p-phenylene diisocyanate, 4,4′-diphenyl diisocyanate, 1,5-naphthalene diisocyanate, 4,4′-diphenylmethane diisocyanate, 2,4- or 2,6-tolylene diisocyanate, 4,4′-toluidine diisocyanate, and 4,4′-diphenyl ether diisocyanate.

The polyisocyanate compound other than the diisocyanate compound includes an aliphatic polyisocyanate compound, an alicyclic polyisocyanate compound, an aromatic and aliphatic polyisocyanate compound, an aromatic polyisocyanate compound, and the like. The concrete examples of these are exemplified below.

The aliphatic polyisocyanate compound includes lysine triisocyanate, 1,4,8-triisocyanato octane, 1,6,11-triisocyanato undecane, 1,8-diisocyanato-4-isocyanato methyl octane, 1,3,6-triisocyanato hexane, 2,5,7-trimethyl-1,8-diisocyanato-5-isocyanato methyl octane and the like.

The alicyclic polyisocyanate compound includes 1,3,5-triisocyanatocyclohexane, 1,3,5-trimethylisocyanatocyclohexane, 3-isocyanato methyl-3,3,5-trimethylcyclohexylisocyanate, 2-(3-isocyanatopropyl)-2,5-di(isocyanatomethyl)-bicyclo[2,2,1]heptane, 2-(3-isocyanatopropyl)-2,6-di(isocyanatomethyl)-bicyclo[2,2,1]heptane, 3-(3-isocyanatopropyl)-2,5-di(isocyanatomethyl)-bicyclo[2,2,1]heptane, 5-(2-isocyanatoethyl)-2-isocyanatomethyl-3-(3-isocyanatopropyl)-bicyclo[2,2,1]heptane, 6-(2-isocyanatoethyl)-2-isocyanatomethyl-3-(3-isocyanatopropyl)-bicyclo[2,2,1]heptane, 5-(2-isocyanatoethyl)-2-isocyanatomethyl-2-(3-isocyanatopropyl)-bicyclo[2-,2,1]heptane, 6-(2-isocyanatoethyl)-2-isocyanatomethyl-2-(3-isocyanatopropyl)-bicyclo[2-,2,1]heptane and the like.

The aliphatic and aromatic polyisocyanate compound includes 1,3,5-triisocyanato methyl benzene and the like.

The aromatic polyisocyanate compound includes triphenylmethane-4,4′,4″-triisocyanate, 1,3,5-triisocyanato benzene, 2,4,6-triisocyanatotoluene, 4,4′-diphenylmethane-2,2′,5,5′-tetraisocyanate, polymethylene polyphenyl polyisocyanate and the like.

Further, the polyisocyanate compound includes an allophanate-modified product, a biuret modified product, an isocyanurate modified product and the like, which are obtained by using various polyisocyanate compounds as mentioned above.

Among these, the aromatic diisocyanate compound and the aromatic and aliphatic polyisocyanate compound are preferable due to the excellent adhesive properties of the curable composition. Especially, 4,4′-diphenyl methane diisocyanate, 2,4- or 2,6-tolylene diisocyanate, and polymethylene polyphenyl polyisocyanate are preferable, and 4,4′-diphenyl methane diisocyanate is most preferable.

The aliphatic diisocyanate compound, the alicyclic diisocyanate compound, the aliphatic polyisocyanate, and the alicyclic polyisocyanate are preferable due to the excellent weather resistance of obtained cured products. Among these, hexamethylene diisocyanate, isophorone diisocyanate and isocyanurate modified products thereof are preferable.

The polyisocyanate (B) of the polyurethane composition can be a blocked isocyanate obtained by masking an isocyanate group with a masking agent and inactivating the isocyanate group at ambient temperature. In the blocked isocyanate masked with the blocking agent, the blocking agent is dissociated by heating (for example, 130 to 160° C.) or humidity to regenerate the isocyanate group. Therefore, the blocked isocyanate can be combined with the polyol (A) in one pack type heat or moisture curable composition.

The blocking agent includes an alcohol blocking agent, a phenol blocking agent, an oxime blocking agent, a triazole blocking agent, a caprolactam blocking agent and the like.

Preferred examples of the alcohol blocking agent include methanol, ethanol, propanol, hexanol, laurylalcohol, t-butanol, cyclohexanol and the like. Preferred examples of the phenol blocking agent include xylenol, naphthol, 4-methyl-2,6-di-t-butylphenol. Preferred examples of the oxime blocking agent include 2,6-dimethyl-4-heptanone oxime, methylethylketoxime, 2-heptanone oxime and the like. Preferred example of the triazole blocking agent includes 1,2,4-triazole and the like. Preferred example of the caprolactam blocking agent includes ε-caprolactam and the like. 3,5-dimethylpyrrazole and the like are used suitably. Among these, methanol, xylenol, and methylethylketoxime are preferable.

As the constituent of the curable polyurethane composition, the amount of the polyisocyanate (B) is preferably from 6 to 50 wt. % of the total polyurethane composition.

In an embodiment, the at least one polyisocyanate is selected from the group consisting of an aliphatic polyisocyanate and an aromatic polyisocyanate.

In an embodiment, the at least one polyisocyanate is selected from the group consisting of aliphatic diisocyanates, aliphatic triisocyanates, aromatic diisocyanates, aromatic triisocyanates, and reaction products of the above with one or more polyols.

Prepolymer from Previous Reaction of Polyol (A) and Polyisocyanate (B)

In the present invention, it is possible that the polyol (A) is reacted with the polyisocyanate (B) at the curing of the curable composition. Also, it is possible that a prepolymer obtained by previously reacting to a part, or all of, the polyol (A) and the polyisocyanate (B) can be used in the curable composition. By using the urethane prepolymer, the control of reactivity of urethane reaction, the control of the mixing ratio of the two-component curable composition, the adjustment of the viscosity of the curable composition and the suppression of the foaming at curing are accomplished.

Thus, the curable composition may contain a urethane prepolymer produced from the reaction of the polyol (A) and the polyisocyanate (B).

A method for synthesizing a urethane prepolymer may be a conventional method. For example, the urethane prepolymer may be obtained by feeding a compound having two or more active hydrogens at a terminal of polyol and the like to a closed reactor equipped with a stirrer, a reflux condenser, a vacuum dehydration device, a nitrogen inlet, dehydrating the compound under reduced pressure, and formulating an isocyanate compound, and reacting the compound and the isocyanate compound under nitrogen streaming at 70 to 100° C. for 3 to 8 hours.

The urethane prepolymer having an isocyanate group can be obtained by adjusting the equivalent ratio (NCO/active hydrogen containing group) of isocyanate (NCO) group of the polyisocyanate (B) to the active hydrogen containing group of the polyol (A), to a value greater than 1. It is preferable that the curable polyurethane composition contains a urethane prepolymer having the isocyanate group obtained from the range of 1.05 to 5.0 of the equivalent ratio. In the case of less than 1.05 of the equivalent ratio, the workability of the curable composition becomes difficult due to the high viscosity of the prepolymer. In addition, in the case of greater than 5.0 of the equivalent ratio, the amount of foaming may become much during the cure, and the strength of the cured product obtained may become small. The equivalent ratio (NCO/active hydrogen containing group) is more preferably 1.5 to 4.0, and even preferably 2.0 to 3.0.

By using the urethane prepolymer, it is possible that the curable composition in which all of the active hydrogen-containing group of the polyol (A) is reacted is used as the one pack type humidity curable composition capable of curing from the reaction of the isocyanate group of the prepolymer with humidity of the atmosphere.

In addition, a urethane prepolymer having a hydroxyl group may be obtained by controlling the equivalent ratio to a value of less than 1. In some embodiments, it is preferable that the curable polyurethane composition contains a urethane prepolymer obtained from the 0.2 to 0.95 of the equivalent ratio. The equivalent ratio is more preferably 0.25 to 0.7, and even preferably 0.30 to 0.5.

Preferably, the first component (A) and the second component (B) are combined in a volume ratio of from 10:1 to 1:10. This is advantageous because the ratio of functional equivalents of isocyanate to active hydrogen compounds can be more precisely maintained within this range.

In embodiments, the polyurethane curable composition further comprises a tackifier or plasticizer in an amount of from about 0.1 to about 50% by weight of the composition. In one embodiment, the plasticizer is an organic ester such as, for example, triethylene glycol bis(2-ethylhexanoate).

In embodiments, the polyurethane curable composition further comprises at least one additive selected from pigment, dispersant, antioxidant, UV absorber, hindered amine light stabilizer, defoamers, rheology modifiers, or combinations thereof.

In embodiments, the polyurethane curable composition further comprises at least one catalyst. In one embodiment, the catalyst is an organo-Bismuth compound.

Referring to FIG. 1, once cured, the polyurethane composition forms a membrane 22 around the object penetrating through the pre-applied waterproofing membrane to seal and waterproof the base of the penetrating object where it intersects with the pre-applied waterproofing membrane. In some embodiments, the polyurethane composition is applied at a thickness of from 0.5 to 50 mm. In other embodiments, the polyurethane composition is applied at a thickness of from 1 to 25 mm.

Components (A) and (B) can be applied by any means known in the art. Preferably, the components (A) and (B) are applied by spray-coating. As used herein, the term “spray-coating” means establishing a coating layer onto a substrate, such as a pre-applied waterproofing membrane and an object penetrating through, a composition that hardens into a membrane. The spray-coating is preferably done by spraying two parts of the composition which are blended within the spray-nozzle or piping or tubing or other conduit that feeds coating composition components from storage containers or tanks to the spray nozzle. The use of two-component systems in spray applications is known in the art.

By “hardened”, those having skill in the waterproofing of buildings and construction will understand that the waterproofing membrane/seal should be dry to hand touch and should not displace (in the manner of a liquid) when spray-applied onto the substrate.

The polyurethane compositions provide for excellent bonding among components used for establishing a monolithic barrier in a pre-applied waterproofing construction application, even if varied materials, surfaces, and surface texturing are involved, and especially where seams and penetrations occur and various surfaces of waterproofing membranes, pipes and other conduits, rebar, and other materials come into contact.

Embodiments of the current invention provide a beneficial combination of properties, for example, the polyurethane liquid detailing membrane exhibits adhesion to both a plastic substrate and post-cast concrete, such that it could be applied directly onto a waterproof sheet and produce a layer that is operative to bond to both the waterproofing membrane and provide the unique bond to post-cast concrete.

The method of the present invention includes the step of allowing the polyurethane composition to cure, wherein the composition, after curing for 7 days at 23° C., exhibits a Young's modulus (E) of from 0.05 to 1.0 MPa. Young's modulus (E) is a mechanical property that measures the tensile or compressive stiffness of a solid material when the force is applied lengthwise. The purpose of a Young's modulus (E) of from 0.05 to 1.0 MPa is to provide the range of an easily measured viscoelastic property that ensures adequate strength and adhesion.

In some embodiments, to achieve a Young's modulus (E) of from 0.05 to 1.0 MPa, either the polyol (A) or the polyisocyanate (B) or both (A) and (B) comprise(s) a filler in an amount of from about 1 to about 50% by weight of the composition. The filler may be, for example, calcium carbonate, talc, amorphous silica, magnesium silicate, mica, graphite, or combinations thereof. Young's modulus (E) can also be controlled by the degree of crosslinking in the polyurethane.

The method of the present invention includes the step of applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017). This adhesion functions to resist water migration in the event that water reaches the concrete-membrane interface.

In one embodiment, upon curing, the polyurethane composition exhibits an adhesion greater than 3 pounds per linear inch (pli) according to modified ASTM D903-98(2017) to the concrete cast against it. In another embodiment, upon curing, the polyurethane composition exhibits an adhesion >3 pli according to ASTM D903-98(2017) to the substrate on which it is applied, selected from among concrete, metal, HDPE, PVC, and other plastic sheets or films.

The method of the present invention can be used to waterproof below-grade structures.

The polyurethane membrane composition disclosed herein can be used in a variety of ways when acting as a barrier to water, air, and/or vapor. When functioning as a waterproofing membrane, it is typically applied as a detailing membrane—such as at overlaps, seams, pipe or rebar penetrations, or other high-risk areas for water penetration—due in part to its liquid application. As a detailing membrane, the composition can function in conjunction with other waterproofing membranes, such as GCP's PREPRUFE® membranes.

In yet another embodiment, the present invention provides a composition package for providing a polyurethane composition for forming a waterproofing membrane against at least one article penetrating through a pre-applied waterproofing membrane, the package comprising: a first component (A) comprising at least one polyol in the amount of 20-90 wt. % based on total weight of the polyurethane composition; and a second component (B) comprising at least one polyisocyanate having an NCO content in the range of from 2.0 to 50.0 wt. % measured according to ASTM D2572-19, with respect to said at least one polyisocyanate, wherein when the first component (A) and the second component (B) are mixed in a volume ratio of from 10:1 to 1:10 to form a polyurethane composition and cured for 7 days at 23° C., the polyurethane exhibits a Young's modulus (E) of from 0.05 to 1.0 MPa, and wherein the polyurethane composition, when cured and in contact with hardened concrete, exhibits a peel adhesion with the hardened concrete is 3.0-50.0 pounds per linear inch (pli) or 0.525 to 8.756 Newtons per mm according to modified ASTM D903-98 (2017). The concrete can be applied to the cured polyurethane in a wet state and harden while in contact with the polyurethane composition.

In yet another embodiment, the present invention provides a composition package for providing a polyurethane composition for forming a waterproofing membrane against at least one article penetrating through a pre-applied waterproofing membrane, the package comprising: a first component (A) comprising at least one polyol in the amount of 7-90 wt. % based on total weight of the polyurethane composition; and a second component (B) comprising at least one polyisocyanate having an NCO content in the range of from 2.0 to 50.0 wt. % measured according to ASTM D2572-19, with respect to said at least one polyisocyanate, wherein when the first component (A) and the second component (B) are mixed in a volume ratio of from 10:1 to 1:10 to form a polyurethane composition and cured for 7 days at 23° C., the polyurethane exhibits a Young's modulus (E) of from 0.05 to 1.0 MPa, and wherein the polyurethane composition, when cured and in contact with hardened concrete, exhibits a peel adhesion with the hardened concrete is 3.0-50.0 pounds per linear inch (pli) or 0.525 to 8.756 Newtons per mm according to modified ASTM D903-98 (2017). The concrete can be applied to the cured polyurethane in a wet state and harden while in contact with the polyurethane composition.

The first and second parts of the exemplary composition package as described above are preferably shipped (in separate containers or packages) to the installation or job site, where they are combined (such as by spraying through a single nozzle where they are conveniently mixed together), and applied onto the base of the object penetrating through a pre-applied waterproofing membrane to form a waterproofing seal, after which the polyurethane coating begins to harden and form a waterproofing membrane.

### EMBODIMENTS

Embodiment 1. A method for integrating a pre-applied waterproofing membrane installed against a soil retention structure, wherein the pre-applied waterproofing membrane has at least one article penetrating there through, the method comprising the steps of:
(a) sealing the at least one penetration in the membrane by applying thereto a polyurethane composition by mixing together a first component (A) and a second component B, wherein, the first component (A) comprises at least one polyol in the amount of 7-90 wt. % based on total weight of polyurethane composition, and the second component (B) comprises at least one polyisocyanate having an NCO content in the range of from 2.0 to 50.0 wt. % measured according to ASTM D2572-19, with respect to said at least one polyisocyanate, wherein the first component (A) and the second component (B) are combined in a volume ratio of from 10:1 to 1:10;
(b) allowing the polyurethane composition to cure, wherein the composition, after curing for 7 days at 23° C., exhibits a Young's modulus (E) of from 0.05 to 1.0 MPa; and
(c) applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017).

Embodiment 2. The method of embodiment 1 wherein the soil-retention system is selected from the group consisting of lagging, formwork, shotcrete, mud slabs, and crushed stone.

Embodiment 3. The method of embodiment 1 wherein the at least one penetration is selected from the group consisting of a pipe, a steel reinforcement bar, a rock anchor, screws, and combinations thereof.

Embodiment 4. The method of embodiment 1 wherein component (A) of the polyurethane composition further comprises at least one triol in the amount of from 0.10-10 wt. % based on total weight of component (A).

Embodiment 5. The method of embodiment 1 wherein the polyurethane composition is applied at a thickness of from 0.5 to 50 mm.

Embodiment 6. The method of embodiment 5 wherein the polyurethane composition is applied at a thickness of from 1 to 25 mm.

Embodiment 7. The method of embodiment 1 wherein in sealing step a), the polyurethane composition further comprises a tackifier, plasticizer, or mixture thereof in an amount of about 1.0 to 50% by weight of the polyurethane composition.

Embodiment 8. The method of embodiment 1 wherein, in sealing step a), the polyurethane composition comprises at least one filler in an amount of about 1 to about 50% by weight of the total polyurethane composition, wherein the at least one filler is selected from the group consisting of calcium carbonate, talc, amorphous silica, magnesium silicate, mica, graphite, and mixtures thereof.

Embodiment 9. The method of embodiment 1 wherein, in sealing step a), the polyurethane composition further comprises at least one additive selected from the group consisting of pigment, dispersant, antioxidant, UV absorber, hindered amine light stabilizer, adhesion promoter, defoamers, rheology modifiers, and mixtures thereof.

Embodiment 10. The method of embodiment 8 wherein, in sealing step a), the polyurethane composition further comprises at least one additive selected from the group consisting of pigment, dispersant, antioxidant, UV absorber, hindered amine light stabilizer, adhesion promoter, defoamers, rheology modifiers, and mixtures thereof.

Embodiment 11. The method of embodiment 1 wherein, in sealing step a) the polyurethane composition further comprises a catalyst.

Embodiment 12. The method of embodiment 1 wherein the at least one polyisocyanate is selected from the group consisting of an aliphatic polyisocyanate and an aromatic polyisocyanate.

Embodiment 13. The method of embodiment 1 wherein the at least one difunctional polyol is selected from the group consisting of polyethers, polyesters, polyacrylates, polyolefins, polysiloxanes, polycarbonates, castor oil derivatives, fatty acid-based polyols, and mixtures thereof.

Embodiment 14. The method of embodiment 1 wherein the at least one polyisocyanate is selected from the group consisting of aliphatic diisocyanates, aliphatic triisocyanates, aromatic diisocyanates, aromatic triisocyanates, and reaction products of the above with one or more polyols.

Embodiment 15. A below-grade waterproofing system made according to embodiment 1.

Embodiment 16. A package for providing a polyurethane composition, the package comprising:
(a) a first component (A) comprising at least one polyol in the amount of 7-90 wt. % based on total weight of the polyurethane composition; and
(b) a second component (B) comprising at least one polyisocyanate having an NCO content in the range of from 2.0 to 50.0 wt. % measured according to ASTM D2572-19, with respect to said at least one polyisocyanate,
(c) wherein when the first component (A) and the second component (B) are mixed in a volume ratio of from 10:1 to 1:10 to form a polyurethane composition and cured for 7 days at 23° C., the polyurethane exhibits a Young's modulus (E) of from 0.05 to 1.0 MPa, and wherein the polyurethane composition, when cured and in contact with hardened concrete, exhibits a peel adhesion with the hardened concrete is 3.0-50.0 pounds per linear inch (pli) or 0.525 to 8.756 Newtons per mm according to modified ASTM D903-98 (2017).

Embodiment 17. The package of embodiment 16 wherein the first component (A) further comprises at least one triol in the amount of from 0.10-10 wt. % based on the total weight of component (A).

Embodiment 18. The package of embodiment 16 wherein at least one of the first component (A) and the second component (B) further comprises a tackifier, plasticizer, or mixture thereof in an amount of about 1.0 to 50% by weight of the polyurethane composition.

Embodiment 19. The package of embodiment 16 wherein at least one of the first component (A) and the second component (B) further comprises at least one filler in an amount of from about 1 to about 50% by weight of the total polyurethane composition, wherein the at least one filler is selected from the group consisting of calcium carbonate, talc, amorphous silica, magnesium silicate, mica, graphite, and mixtures thereof.

Embodiment 20. The package of embodiment 19 wherein at least one of the first component (A) and the second component (B) further comprises at least one additive selected from the group consisting of pigment, dispersant, antioxidant, UV absorber, hindered amine light stabilizer, adhesion promoter, defoamers, rheology modifiers, and mixtures thereof.

Embodiment 21. The package of embodiment 16 wherein at least one of the first component (A) and the second component (B) further comprises at least one additive selected from the group consisting of pigment, dispersant, antioxidant, UV absorber, hindered amine light stabilizer, adhesion promoter, defoamers, rheology modifiers, and mixtures thereof.

Embodiment 22. The package of embodiment 16 wherein at least one of the first component (A) and the second component (B) further comprises a catalyst.

Embodiment 23. The package of embodiment 16 wherein the at least one polyisocyanate is selected from the group consisting of an aliphatic polyisocyanate and an aromatic polyisocyanate.

Embodiment 24. The package of embodiment 1 wherein the at least one difunctional polyol is selected from the group consisting of polyethers, polyesters, polyacrylates, polyolefins, polysiloxanes, polycarbonates, castor oil derivatives, fatty acid-based polyols, and mixtures thereof.

Embodiment 25. The package of embodiment 1 wherein the at least one polyisocyanate is selected from the group consisting of aliphatic diisocyanates, aliphatic triisocyanates, aromatic diisocyanates, aromatic triisocyanates, and reaction products of the above with one or more polyols.

Embodiment 26. A method for integrating a pre-applied waterproofing membrane installed against a soil retention structure, wherein the pre-applied waterproofing membrane has at least one article penetrating there through, the method comprising the steps of:
(a) sealing the at least one penetration in the membrane by applying thereto a polyurethane composition by mixing together a first component (A) and a second component B, wherein, the first component (A) comprises at least one polyol in the amount of 20-90 wt. % based on total weight of polyurethane composition, and the second component (B) comprises at least one polyisocyanate having an NCO content in the range of from 2.0 to 50.0 wt. % measured according to ASTM D2572-19, with respect to said at least one polyisocyanate, wherein the first component (A) and the second component (B) are combined in a volume ratio of from 10:1 to 1:10;
(b) allowing the polyurethane composition to cure, wherein the composition, after curing for 7 days at 23° C., exhibits a Young's modulus (E) of from 0.05 to 1.0 MPa; and
(c) applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017).

Embodiment 27. The method of embodiment 26 wherein the soil-retention system is selected from the group consisting of lagging, formwork, shotcrete, mud slabs, and crushed stone.

Embodiment 28. The method of embodiment 26 wherein the at least one penetration is selected from the group consisting of a pipe, a steel reinforcement bar, a rock anchor, screws, and combinations thereof.

Embodiment 29. The method of embodiment 26 wherein component (A) of the polyurethane composition further comprises at least one triol in the amount of from 0.10-10 wt. % based on the total weight of component (A).

Embodiment 30. The method of embodiment 26 wherein the polyurethane composition is applied at a thickness of from 0.5 to 50 mm.

Embodiment 31. The method of embodiment 30 wherein the polyurethane composition is applied at a thickness of from 1 to 25 mm.

Embodiment 32. The method of embodiment 26 wherein in sealing step a), the polyurethane composition further comprises a tackifier, plasticizer, or mixture thereof in an amount of about 1.0 to 50% by weight of the polyurethane composition.

Embodiment 33. The method of embodiment 26 wherein, in sealing step a), the polyurethane composition comprises at least one filler in an amount of about 1 to about 50% by weight of the total polyurethane composition, wherein the at least one filler is selected from the group consisting of calcium carbonate, talc, amorphous silica, magnesium silicate, mica, graphite, and mixtures thereof.

Embodiment 34. The method of embodiment 26 wherein, in sealing step a), the polyurethane composition further comprises at least one additive selected from the group consisting of pigment, dispersant, antioxidant, UV absorber, hindered amine light stabilizer, adhesion promoter, defoamers, rheology modifiers, and mixtures thereof.

Embodiment 35. The method of embodiment 33 wherein, in sealing step a), the polyurethane composition further comprises at least one additive selected from the group consisting of pigment, dispersant, antioxidant, UV absorber, hindered amine light stabilizer, adhesion promoter, defoamers, rheology modifiers, and mixtures thereof.

Embodiment 36. The method of embodiment 26 wherein, in sealing step a) the polyurethane composition further comprises a catalyst.

Embodiment 37. The method of embodiment 26 wherein the at least one polyisocyanate is selected from the group consisting of an aliphatic polyisocyanate and an aromatic polyisocyanate.

Embodiment 38. The method of embodiment 26 wherein the at least one difunctional polyol is selected from the group consisting of polyethers, polyesters, polyacrylates, polyolefins, polysiloxanes, polycarbonates, castor oil derivatives, fatty acid-based polyols, and mixtures thereof.

Embodiment 39. The method of embodiment 26 wherein the at least one polyisocyanate is selected from the group consisting of aliphatic diisocyanates, aliphatic triisocyanates, aromatic diisocyanates, aromatic triisocyanates, and reaction products of the above with one or more polyols.

Embodiment 40. A below-grade waterproofing system made according to embodiment 26.

Embodiment 41. A package for providing a polyurethane composition, the package comprising:
(a) a first component (A) comprising at least one polyol in the amount of 20-90 wt. % based on total weight of the polyurethane composition; and
(b) a second component (B) comprising at least one polyisocyanate having an NCO content in the range of from 2.0 to 50.0 wt. % measured according to ASTM D2572-19, with respect to said at least one polyisocyanate,
(c) wherein when the first component (A) and the second component (B) are mixed in a volume ratio of from 10:1 to 1:10 to form a polyurethane composition and cured for 7 days at 23° C., the polyurethane exhibits a Young's modulus (E) of from 0.05 to 1.0 MPa, and wherein the polyurethane composition, when cured and in contact with hardened concrete, exhibits a peel adhesion with the hardened concrete is 3.0-50.0 pounds per linear inch (pli) or 0.525 to 8.756 Newtons per mm according to modified ASTM D903-98 (2017).

Embodiment 42. The package of embodiment 41 wherein the first component (A) further comprises at least one triol in the amount of from 0.10-10 wt. % based on the total weight of component (A).

Embodiment 43. The package of embodiment 41 wherein at least one of the first component (A) and the second component (B) further comprises a tackifier, plasticizer, or mixture thereof in an amount of about 1.0 to 50% by weight of the polyurethane composition.

Embodiment 44. The package of embodiment 41 wherein at least one of the first component (A) and the second component (B) further comprises at least one filler in an amount of from about 1 to about 50% by weight of the total polyurethane composition, wherein the at least one filler is selected from the group consisting of calcium carbonate, talc, amorphous silica, magnesium silicate, mica, graphite, and mixtures thereof.

Embodiment 45. The package of embodiment 44 wherein at least one of the first component (A) and the second component (B) further comprises at least one additive selected from the group consisting of pigment, dispersant, antioxidant, UV absorber, hindered amine light stabilizer, adhesion promoter, defoamers, rheology modifiers, and mixtures thereof.

Embodiment 46. The package of embodiment 41 wherein at least one of the first component (A) and the second component (B) further comprises at least one additive selected from the group consisting of pigment, dispersant, antioxidant, UV absorber, hindered amine light stabilizer, adhesion promoter, defoamers, rheology modifiers, and mixtures thereof.

Embodiment 47. The package of embodiment 41 wherein at least one of the first component (A) and the second component (B) further comprises a catalyst.

Embodiment 48. The package of embodiment 41 wherein the at least one polyisocyanate is selected from the group consisting of an aliphatic polyisocyanate and an aromatic polyisocyanate.

Embodiment 49. The package of embodiment 41 wherein the at least one difunctional polyol is selected from the group consisting of polyethers, polyesters, polyacrylates, polyolefins, polysiloxanes, polycarbonates, castor oil derivatives, fatty acid-based polyols, and mixtures thereof.

Embodiment 50. The package of embodiment 41 wherein the at least one polyisocyanate is selected from the group consisting of aliphatic diisocyanates, aliphatic triisocyanates, aromatic diisocyanates, aromatic triisocyanates, and reaction products of the above with one or more polyols.

Embodiment 51. The package of embodiment 16 wherein the hardened concrete was applied to the cured polyurethane in a wet state and hardened while in contact with the polyurethane.

Embodiment 52. The package of embodiment 41 wherein the hardened concrete was applied to the cured polyurethane in a wet state and hardened while in contact with the polyurethane.

### Examples

While the invention is described herein using a limited number of embodiments, these specific embodiments are not intended to limit the scope of the invention as otherwise described and claimed herein. Modifications and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total liquid detailing membrane composition, unless otherwise specified.

### Comparative Example

Comparative waterproofing compositions/materials were tested (Comparative Example) or formulated and tested (Examples 1-7) in accordance with the components listed in Table 1, where the compositions resulted in the properties listed in Table 2. The Comparative Example is a commercial two-component polyurethane sealant for below-grade waterproofing. The aromatic polyisocyanate is an aromatic isocyanate functional polyether prepolymer with the NCO content listed in the table. Suprasec 2054 is an alternative aromatic polyisocyanate provided by Huntsman. The poly(alkylene oxide) polyol is Multranol 9111 from Covestro. The castor oil-based polyol was Albodur 1054 from Alberdingk Boley. The plasticizer was Foralyn 5029-F from Synthomer. The Rheology modifier was Rheobyk D-410 from BYK Additives. The wetting additive was BYK W-940. The UV absorber and light stabilizer were Tinuvin 400 and Tinuvin 292 respectively, both from BASF. The antioxidant was Irganox 245 from BASF.

TABLE 1
Compositions of Examples

| | Ex. 1 | Ex. 2 | Ex. 3 | Ex. 4 | Ex. 5 | Ex. 6 | Ex. 7 |
|---|---|---|---|---|---|---|---|
| Aromatic polyisocyanate (% w/w) | 27.64 | 33.44 | 47.46 | 0 | 55.29 | 40.60 | 41.56 |
| Suprasec 2054 (% w/w) | 0 | 0 | 0 | 38.82 | 0 | 0 | 0 |
| Polyisocyanate NCO wt % | 4.9 | 4.9 | 4.9 | 14.8 | 4.9 | 4.9 | 4.9 |
| Poly(alkylene oxide) polyol (% w/w) | 46.41 | 40.11 | 24.91 | 0 | 0 | 0 | 0 |
| Castor oil-based polyol (% w/w) | 0 | 0 | 0 | 34.06 | 13.89 | 8.32 | 7.45 |
| Triethanolamine (% w/w) | 0.31 | 0.80 | 1.98 | 0 | 0 | 0 | 0.46 |
| Isophoronediamine (% w/w) | 0-1 | 0-1 | 0-1 | 0-1 | 0-1 | 0-1 | 0-1 |
| Plasticizer (% w/w) | 0 | 0 | 0 | 0 | 0 | 20 | 20 |
| Organobismuth catalyst (% w/w) | 0-1 | 0-1 | 0-1 | 0-1 | 0-1 | 0-1 | 0-1 |
| Calcium carbonate (% w/w) | 20 | 20 | 20 | 20 | 20 | 20 | 20 |
| Titanium dioxide/pigment (% w/w) | 0-2 | 0-2 | 0-2 | 0-2 | 0-2 | 0-2 | 0-2 |
| Rheology modifier (% w/w) | 1-3 | 1-3 | 1-3 | 1-3 | 1-3 | 1-3 | 1-3 |
| Wetting/dispersing additive (% w/w) | 0-1 | 0-1 | 0-1 | 0-1 | 0-1 | 0-1 | 0-1 |
| UV Absorber (% w/w) | 1-2 | 1-2 | 1-2 | 1-3 | 1-3 | 1-3 | 1-3 |
| Light Stabilizer (% w/w) | 1-2 | 1-2 | 1-2 | 1-2 | 1-2 | 1-2 | 1-2 |
| Antioxidant (% w/w) | 1-2 | 1-2 | 1-2 | 1-2 | 1-2 | 1-2 | 1-2 |

TABLE 2
Properties of Examples

| | Comp. | | | | | | | |
|---|---|---|---|---|---|---|---|---|
| Property | Ex. 1 | Ex. 1 | Ex. 2 | Ex. 3 | Ex. 4 | Ex. 5 | Ex. 6 | Ex. 7 |
| Young's | 2.32 | 0.12 | 0.57 | 1.69 | 0.86 | 0.35 | 0.10 | 0.29 |
| modulus | | | | | | | | |
| (MPa) | | | | | | | | |
| Adhesion | 2.0 | 16.5 | 4.5 | 1.1 | 21.1 | 22.3 | 17.6 | 12.1 |
| to rigid | | | | | | | | |
| PVC (pli) | | | | | | | | |
| Adhesion to | 37.2 | 16.5 | 9.6 | 5.9 | 15.0 | 22.4 | 24.7 | 38.2 |
| concrete | | | | | | | | |
| (pli) | | | | | | | | |
| Adhesion | 3.3 | 5.8 | 0.5 | 0.1 | 21.4 | 24.1 | 19.9 | 7.06 |
| to steel | | | | | | | | |
| (pli) | | | | | | | | |
| Adhesion | 1.81 | 7.57 | 5.17 | 0.50 | 9.44 | 10.2 | 8.54 | 2.9 |
| to post- | | | | | | | | |
| cast | | | | | | | | |
| concrete | | | | | | | | |
| (pli) | | | | | | | | |

### Examples

Exemplary liquid waterproofing compositions were formulated in accordance with the components listed in Table 1, where the compositions resulted in the properties listed in Table 2. Comparative Example 1 is a commercial 2-component polyurethane sealant used in below-grade waterproofing. The exemplary compositions are varied in their resulting Young's modulus (E), controlled by the degree of crosslinking. The inventive examples include at least one isocyanate component, at least one polyol component, fillers, and additives. The polyurethane compositions can be created using the following general methodology. Polyol(s), catalyst, fillers, additives, and pigments are mixed together until particles are fully dispersed, hereafter designated Part A. The isocyanate(s) are added and mixed with the Part A and applied.

Adhesion to rigid PVC, steel, and concrete were tested according to ASTM D903-98(2017). The adhesion to post-cast concrete was tested in accordance with modified ASTM D903-98(2017). A concrete mix with 4,000 psi compressive strength was used to prepare the wet concrete for adhesion to post-cast concrete.

Adhesion to post-cast concrete was tested according to a modified ASTM D903-98(2017) comprising the following steps: First the membrane sample was applied onto a release liner according to the manufacturer's guidelines and cured and conditioned for 7 days at about 23° C., 50% RH. The membrane samples were cut into strips approximately 2″ wide and 6″ long. The membrane samples were assembled in an HDPE mold in a vertical orientation such that the air-facing side of the membrane as-applied faced the interior of the mold. Wet concrete was placed in the mold and against the membrane samples and allowed to cure for at least 7 days before testing according to ASTM D903-98(2017), but at a crosshead speed of 2 inches per minute (at a 90-degree angle with respect to the plane of the sample).

Young's modulus is measured as stress/strain in the linear (or elastic) portion of the stress-strain curve, tested according to ASTM D-412-16 (2021) Method A with specimens punched from Die C, with an initial grip separation of 3 inches, a crosshead speed of 20 inches per minute, and strain is measured by extensometer.

The examples demonstrate that good adhesion to post-cast concrete, greater than 3 pli, can be obtained when the Young's modulus is below a threshold value. Strong adhesion to other substrates can also be provided by formulation or priming. This invention guarantees protection from water ingress due to its double-bonded performance.

The foregoing examples and embodiments were present for illustrative purposes only and not intended to limit the scope of the invention.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall there between.

What is claimed is:

1. A method for integrating a pre-applied waterproofing membrane installed against a soil retention structure, wherein the pre-applied waterproofing membrane has at least one article penetrating there through, the method comprising the steps of:
a. sealing the at least one penetration in the membrane by applying thereto a polyurethane composition by mixing together a first component (A) and a second component B, wherein, the first component (A) comprises at least one polyol in the amount of 7-90 wt. % based on total weight of polyurethane composition, and the second component (B) comprises at least one polyisocyanate having an NCO content in the range of from 2.0 to 50.0 wt. % measured according to ASTM D2572-19, with respect to said at least one polyisocyanate, wherein the first component (A) and the second component (B) are combined in a volume ratio of from 10:1 to 1:10;
b. allowing the polyurethane composition to cure, wherein the composition, after curing for 7 days at 23° C., exhibits a Young's modulus (E) of from 0.05 to 1.0 MPa; and
c. applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017).

2. The method of claim 1 wherein the soil-retention system is selected from the group consisting of lagging, formwork, shotcrete, mud slabs, and crushed stone.

3. The method of claim 1 wherein the at least one penetration is selected from the group consisting of a pipe, a steel reinforcement bar, a rock anchor, screws, and combinations thereof.

4. The method of claim 1 wherein component (A) of the polyurethane composition further comprises at least one triol in the amount of from 0.10-10 wt. % based on total weight of component (A).

5. The method of claim 1 wherein the polyurethane composition is applied at a thickness of from 0.5 to 50 mm.

6. The method of claim 5 wherein the polyurethane composition is applied at a thickness of from 1 to 25 mm.

7. The method of claim 1 wherein in sealing step a), the polyurethane composition further comprises a tackifier, plasticizer, or mixture thereof in an amount of about 1.0 to 50% by weight of the polyurethane composition.

8. The method of claim 1 wherein, in sealing step a), the polyurethane composition comprises at least one filler in an amount of from about 1 to about 50% by weight of the total polyurethane composition, wherein the at least one filler is selected from the group consisting of calcium carbonate, talc, amorphous silica, magnesium silicate, mica, graphite, and mixtures thereof.

9. The method of claim 1 wherein, in sealing step a), the polyurethane composition further comprises at least one additive selected from the group consisting of pigment, dispersant, antioxidant, UV absorber, hindered amine light stabilizer, adhesion promoter, defoamers, rheology modifiers, and mixtures thereof.

10. The method of claim 8 wherein, in sealing step a), the polyurethane composition further comprises at least one additive selected from the group consisting of pigment, dispersant, antioxidant, UV absorber, hindered amine light stabilizer, adhesion promoter, defoamers, rheology modifiers, and mixtures thereof.

11. The method of claim 1 wherein, in sealing step a) the polyurethane composition further comprises a catalyst.

12. The method of claim 1 wherein the at least one polyisocyanate is selected from the group consisting of an aliphatic polyisocyanate and an aromatic polyisocyanate.

13. The method of claim 1 wherein the at least one difunctional polyol is selected from the group consisting of polyethers, polyesters, polyacrylates, polyolefins, polysiloxanes, polycarbonates, castor oil derivatives, fatty acid-based polyols, and mixtures thereof.

14. The method of claim 1 wherein the at least one polyisocyanate is selected from the group consisting of aliphatic diisocyanates, aliphatic triisocyanates, aromatic diisocyanates, aromatic triisocyanates, and reaction products of the above with one or more polyols.

15. A below-grade waterproofing system made according to claim 1.

16. A package for providing a polyurethane composition, the package comprising:
a. a first component (A) comprising at least one polyol in the amount of 7-90 wt. % based on total weight of the polyurethane composition; and
b. a second component (B) comprising at least one polyisocyanate having an NCO content in the range of from 2.0 to 50.0 wt. % measured according to ASTM D2572-19, with respect to said at least one polyisocyanate,
wherein when the first component (A) and the second component (B) are mixed in a volume ratio of from 10:1 to 1:10 to form a polyurethane composition and cured for 7 days at 23° C., the polyurethane exhibits a Young's modulus (E) of from 0.05 to 1.0 MPa, and wherein the polyurethane composition, when cured and in contact with hardened concrete, exhibits a peel adhesion with the hardened concrete is 3.0-50.0 pounds per linear inch (pli) or 0.525 to 8.756 Newtons per mm according to modified ASTM D903-98 (2017).

17. The package of claim 16 wherein the first component (A) further comprises at least one triol in the amount of from 0.10-10 wt. % based on total weight of component (A).

18. The package of claim 16 wherein at least one of the first component (A) and the second component (B) further comprises a tackifier, plasticizer, or mixture thereof in an amount of about 1.0 to 50% by weight of the polyurethane composition.

19. The package of claim 16 wherein at least one of the first component (A) and the second component (B) further comprises at least one filler in an amount of from about 1 to about 50% by weight of the total polyurethane composition, wherein the at least one filler is selected from the group consisting of calcium carbonate, talc, amorphous silica, magnesium silicate, mica, graphite, and mixtures thereof.

20. The package of claim 19 wherein at least one of the first component (A) and the second component (B) further comprises at least one additive selected from the group consisting of pigment, dispersant, antioxidant, UV absorber, hindered amine light stabilizer, adhesion promoter, defoamers, rheology modifiers, and mixtures thereof.

21. The package of claim 16 wherein at least one of the first component (A) and the second component (B) further comprises at least one additive selected from the group consisting of pigment, dispersant, antioxidant, UV absorber, hindered amine light stabilizer, adhesion promoter, defoamers, rheology modifiers, and mixtures thereof.

22. The package of claim 16 wherein at least one of the first components (A) and the second component (B) further comprises a catalyst.

23. The package of claim 16 wherein the at least one polyisocyanate is selected from the group consisting of an aliphatic polyisocyanate and an aromatic polyisocyanate.

24. The package of claim 16 wherein the at least one difunctional polyol is selected from the group consisting of polyethers, polyesters, polyacrylates, polyolefins, polysiloxanes, polycarbonates, castor oil derivatives, fatty acid-based polyols, and mixtures thereof.

25. The package of claim 16 wherein the at least one polyisocyanate is selected from the group consisting of aliphatic diisocyanates, aliphatic triisocyanates, aromatic diisocyanates, aromatic triisocyanates, and reaction products of the above with one or more polyols.

26. The package of claim 16 wherein the hardened concrete was applied to the cured polyurethane in a wet state and hardened while in contact with the polyurethane.

27. A method for integrating a pre-applied waterproofing membrane installed against a soil retention structure, wherein the pre-applied waterproofing membrane has at least one article penetrating there through, the method comprising the steps of:
a. sealing the at least one penetration in the membrane by applying thereto a polyurethane composition by mixing together a first component (A) and a second component B, wherein, the first component (A) comprises at least one polyol in the amount of 20-90 wt. % based on total weight of polyurethane composition, and the second component (B) comprises at least one polyisocyanate having an NCO content in the range of from 2.0 to 50.0 wt. % measured according to ASTM D2572-19, with respect to said at least one polyisocyanate, wherein the first component (A) and the second component (B) are combined in a volume ratio of from 10:1 to 1:10;
b. allowing the polyurethane composition to cure, wherein the composition, after curing for 7 days at 23° C., exhibits a Young's modulus (E) of from 0.05 to 1.0 MPa; and
c. applying concrete against the pre-applied waterproofing membrane and around the at least one penetration sealed by the polyurethane composition and allowing the concrete to harden against and adhere to the membranes and polyurethane composition, wherein the peel adhesion between the hardened concrete and cured polyurethane composition is 3.0-50.0 pounds per linear inch (pli) or 0.525 to 8.756 Newtons per mm according to modified ASTM D903-98 (2017).
